(19) United States
(12) Patent Application Publication
(10) Pub. No.: US 2024/0156120 A1
(43) Pub. Date: May 16, 2024

(54) DAIRY-ANALOGUE COMPOSITION

(71) Applicant: AAK AB (publ,), Malmö (SE)

(72) Inventors: Håkan MALMROS, Malmö (SE); Josefin LUNDIN, Malmö (SE); Charlotta TUDESJÖ, Malmö (SE); Magnus HÅKANSSON, Malmö (SE); Stefan OLOFSSON, Malmö (SE); Gabrielle GOMEZ, Malmö (SE)

(21) Appl. No.: 18/551,280

(22) PCT Filed: Mar. 22, 2022
(86) PCT No.: PCT/SE2022/050273

§ 371 Date: Sep. 19, 2023

(30) Foreign Application Priority Data
Mar. 22, 2021 (SE) 2130079-3

(51) Int. Cl. A23C 20/02; A23D 9/00; A23G 9/32; A23L 9/20

(52) U.S. Cl. CPC A23C 20/02; A23D 9/00; A23G 9/327; A23L 9/24

(57) ABSTRACT

A dairy analogue composition comprises up to 90% by weight of water; and from 1% by weight to 80% by weight of a fat composition; wherein the fat composition comprises an interesterified blend of non-tropical vegetable oil and fully hydrogenated non-tropical vegetable oil.

### FIELD OF THE INVENTION

The invention relates to dairy analogue compositions comprising a fat composition, starch, water, and optionally non-animal protein, and the use of said dairy analogue compositions in food products. In particular, the invention relates to the use of certain fat compositions in dairy analogue compositions to improve various properties of the dairy analogue compositions.

### BACKGROUND OF THE INVENTION

There is an increasing demand for plant-based foods due to consumers' increasing desire to eat healthy, sustainably sourced food products and to generally lower their meat and dairy intake. There is also an increasing number of vegans who require food products to be completely absent of animal-derived products for ethical and health reasons.

This has led to the development of various plant-based food products such as plant-based meats (meat analogue compositions) and plant-based cheeses (cheese analogue compositions) which aim to mimic certain qualities of the animal-derived meat and cheese products, such as the texture, taste and/or appearance. Plant-based alternatives for other dairy applications such as ice cream and other frozen desserts and whipping cream have also been developed.

The typical content of a cheese analogue composition is plant-based fat typically present in an amount of from 15% to 30% by weight of the composition, starch, non-animal protein and water, along with additives such as flavourings and colourings. Typically, the total amount of starch and non-animal protein present in the compositions remains constant between different cheese analogue compositions. Softer cheese analogue compositions such as spreads and soft cheeses will typically contain relatively more water and less starch and protein, with the opposite being the case for hard cheese analogues.

It has been found difficult in the art for plant-based cheeses to effectively mimic the sensory and functional properties of animal-derived dairy cheeses. This challenge is increased by the many different dairy cheeses in existence with different properties (such as hard cheeses; pizza cheese; brie-type cheeses; spreadable cheeses etc.) meaning that many different systems of plant-based cheese with different properties are desired to mimic the many corresponding types of dairy cheese. In dairy based cheeses, the properties of the cheese are determined by many factors. A key factor is the nature of the fat and proteins present in the cheese. Dairy cheese is produced from milk and contains animal milk-derived fats and animal-milk derived proteins such as casein which are key in providing the desired properties of the dairy cheeses. In dairy cheese making, coagulation of milk fats and proteins occurs to produce the cheese as a result of destabilisation of casein micelles present in the milk. It has been found challenging in the art to provide chemical systems derived entirely from non-animal sources that can provide compositions with all of the properties (and the ability to tailor said properties depending on cheese type) of dairy cheese. In particular, it has been found difficult to provide a non-animal derived fat suitable for use in cheese analogue compositions that is suitable for providing all of the desired properties for each of the many different types of cheese analogue composition. Depending on the specific type of cheese analogue composition desired, properties that may need to be tailored and optimised include, but are not limited to, sensory properties like hardness, adhesiveness, cohesiveness, resilience and springiness; functional behavior like ability to slice, ability to handle sliced cheese, ability to handle shredded cheese, ability for the cheese to stretch when heated (for example in pizza applications), reduction of waste during slicing, reduction of waste during shredding, improved quality of sliced cheese and improved quality of shredded cheese.

Current solutions in the cheese analogue field involve using the nature of the fat and the relative amounts of fat, water and starch in the composition to provide and tailor the sensory and functional properties of the cheese analogue compositions. The vast majority of plant-based cheeses in existence use coconut oil as the source of fat. Coconut oil is plant derived and so fulfils the criteria for being suitable for use in vegan food products. Coconut oil also has a higher melting point than many other vegetable derived oils (such as sunflower oil) and so is better at mimicking the properties of animal-derived fats. Animal derived fats typically have higher melting points than vegetable oils. Coconut oil is also preferable over other higher melting point vegetable oils such as palm oil due to the negative environmental effects associated with the production of palm oil. Consequently, the use of coconut oil in cheese analogue compositions as the fat is the current state of the art.

The inventors of the present invention have appreciated that there are certain negative effects and disadvantages resulting from the use of coconut oil in cheese analogue compositions. Firstly, coconut oil is high in saturated fatty acid residues which is undesirable for consumers from a health perspective due to the association of saturated fatty acid residues in fats with heart disease, undesirable cholesterol levels, and related conditions. A further disadvantage of coconut oil is that it often contains high levels of mineral oil saturated hydrocarbons (MOSH) and mineral oil aromatic hydrocarbons (MOAH).

The inventors of the present invention have also appreciated that there is a need in the art for further fat compositions that are suitable for use in other plant-based dairy applications such as plant-based whipping cream and frozen desserts such as ice cream. In applications such as ice cream, it is vital that the non-dairy ice cream has similar sensory properties to dairy ice cream when consumed. For example, it is important that non-dairy ice cream has a similar melting profile to dairy ice cream compositions as this will affect the mouth feel when consumed. If the ice cream composition melts too fast, then the ice cream composition will be unsuitable for use as a frozen dessert as it will melt rapidly when removed from the freezer. In contrast, if the frozen dessert composition melts too slowly in relation to comparable dairy ice cream compositions, then the ice cream will not melt sufficiently quickly when consumed and could result in a waxy sensation when consumed in comparison to a dairy ice cream. The sensory properties of dairy ice creams are typically affected by the milk fats and proteins in the composition. A fat included in a non-dairy ice cream should desirably be able to mimic the properties of the dairy ice cream. The majority of non-dairy ice cream compositions contain coconut oil which aids in providing the above-described effects.

Non-dairy whipping creams are also known in the art. To be suitable for use as a whipping cream, whipping cream compositions must have various properties such as short whipping time, a good overrun (the volume of air whipped into the product), a firm and stable foam and a good mouth feel. In whipped creams, the cream is typically stabilised by fat globules. In dairy whipped creams, good whipping properties are achieved by desorption of milk proteins from the fat globules which causes the fat particles to agglomerate causing partial coalescence of the fat particles. Partial coalescence of the fat globules aids in stabilisation of foam upon whipping. In order to achieve these effects, the nature of the fat composition is important. Emulsifiers are also often important to aid in destabilisation of the emulsion present which aids in the necessary coalescence of the fat particles. In non-dairy whipped creams which do not contain animal proteins, often, interfacially active hydrocolloids such as cellulose ester products are used to provide similar effects to protein in fat particle coalescence. It is also necessary for whipping cream compositions to have storage stability which prevents them thickening when stored in containers prior to use. The selection of the specific fat to include in non-dairy whipping cream is also important in the achievement of the effects described above such as particle coalescence and stability against thickening. Currently, partly or fully hydrogenated palm kernel oil (FH PKO) is commonly used to achieve the above described effects in many non-dairy whipping cream formulations.

In addition to the above, it has been appreciated by the inventors that a further disadvantage of the use of oils such as coconut oil, palm oil and palm kernel oil in dairy analogue compositions is that they are fats derived from plants found only in tropical regions of the world. This is disadvantageous for the manufacturers of dairy-analogue compositions found outside of these regions of the world such as Europe and North America since the tropical fats need to be transported from the regions in which they are grown to Europe and North America which have the largest markets for dairy analogue products. Unfortunately, the majority of naturally occurring vegetable derived fats grown locally in Europe and North America do not have the desired properties (such as high melting points) for inclusion in dairy analogue compositions, or do not provide the same advantages and functionality discussed above associated with coconut oil and other tropical oils. A previous approach to providing a harder, higher melting point fat from a local source for use in food products was to provide a hydrogenated vegetable oil. A locally sourced vegetable oil with a lower melting point can be hydrogenated to increase the saturated fatty acid moiety content of the fat thus increasing its melting point. Hydrogenation can be done either partly (thus leaving some unsaturated fatty acids present in the fat) or fully where 100% (or near) of the unsaturated fatty acid moieties present in the vegetable oil are converted to saturated fatty acid moieties. A disadvantage of using partially hydrogenated fats is the high content of trans unsaturated fatty acids present in them. Trans fatty acids are undesirable for health reasons as they are linked to the incidence of heart disease and higher cholesterol in consumers, amongst other conditions. A disadvantage of fully hydrogenated fat is that the fat typically has a poor melting behaviour resulting in an undesirable and unpleasant waxy mouth feel when included in food products such as dairy analogue compositions.

The inventors of the present invention have thus appreciated that there is a need in the art for a locally sourced non-animal derived fat that can be used in dairy analogue compositions that does not have the negative health implications associated with partially hydrogenated fats, or the disadvantageous sensory properties associated with fully hydrogenated fats discussed above. The inventors have also appreciated that there is a need in the art for such fats that solve or alleviate the problems discussed above associated with the use of coconut oil and other tropical oils in dairy analogue compositions; and that are also suitable for providing a variety of different types of dairy analogue composition with different desired properties such as hard cheese analogues, soft or spreadable cheese analogues, frozen dessert, and whipping cream.

The documents discussed below discuss the utility of certain fat compositions in certain food products. However, the use of the fat compositions in dairy analogue compositions, and the possible advantages associated therewith over the state of the art are not contemplated.

EP2196094 discloses fatty products having a low amount of saturated fat mainly composed of stearic acid and a low percentage of palmitic acid, obtained through interesterification of a fully hydrogenated vegetable oil with a liquid vegetable oil having a very low content in saturated fatty acids. The fatty products are taught for use in manufacturing bakery products such as tarts, biscuits and bread loaves.

US2010/0015280 discloses a functional oil blend comprising less than 1.5 percent trans fatty acids, greater than 6 percent alpha-linolenic acid, less than 32 percent saturated fatty acids where less than about 16 percent of C12:0, C14:0, and C16:0 saturated fatty acids are derived from tropical oil, and a ratio of linolenic acid to alpha-linolenic acid of less than 10. The oil blends are disclosed for use in bakery shortening, spray oil, cookies and crackers.

Zero trans fats from soybean oil and fully hydrogenated soybean oil: Physico-chemical properties and food applications, Ribeiro et Al., Food Research International 42 (2009), 401 to 410 discloses an interesterified blend of fully hydrogenated soybean oil and soybean oil and suggests its use in bakery applications such as shortening and biscuit filling bases.

Similar fat blends are also available commercially and are marketed for use in bakery applications. Such fat blends include Ines 66 (an interesterified blend of sunflower oil and fully hydrogenated sunflower oil) and Rubin 20 (an interesterified blend of rapeseed oil and fully hydrogenated rapeseed oil).

### SUMMARY OF THE INVENTION

The present invention is based on the surprising finding that certain fat compositions are suitable for use in a variety of different types of dairy analogue composition. Surprisingly, it has been found that certain fats typically derived from vegetable sources from non-tropical regions of the world can be used to replace tropical fats such as coconut oil, shea oil, palm oil and palm kernel oil in dairy analogue compositions. As discussed above, for each type of dairy analogue application (such as the wide variety of cheese analogues; frozen dessert analogues and whipped cream analogues), the fat must provide various functional and sensory properties to the dairy analogue composition for said composition to be considered acceptable to the consumer. Surprisingly, the present fat compositions have been found to provide acceptable functional and sensory properties for inclusion in a wide variety of dairy analogue compositions. As a result, these fat compositions can be used as effective replacements for fats currently known in the art for use in dairy analogue compositions, such as coconut oil in cheese analogue compositions and palm kernel oil in whipped cream analogue compositions. An advantage over the use of coconut oil and palm kernel oil is the potential to have an improved nutritional profile relative to coconut oil and palm kernel oil due to having lower amounts of saturated fatty acid residues.

With regard to cheese analogue compositions, it has surprisingly been found by the inventors that the certain fat compositions are suitable for use in providing the desired properties of a variety of different types of cheese analogue compositions (for example all of hard cheese; soft cheese; spreadable cheese etc.). Some prior known fats are only suitable for use in some of these cheese analogue applications, but not all. As an additional advantage, if desired, the specific properties of the fat compositions, such as solid fat content, can be optimized for each of the different types of cheese analogue composition. Furthermore, depending on the specific type of cheese analogue composition desired, it has been found possible to tailor and optimise properties such as sensory properties like hardness, adhesiveness, cohesiveness, resilience and springiness; and functional behavior like ability to slice, ability to handle and ability for the cheese to stretch when heated (for example in pizza applications).

Surprisingly, as well as being suitable for use in a variety of cheese analogue compositions, the present fats have also been found by the inventors as suitable for use in other types of dairy analogue composition such as non-dairy frozen dessert and whipped cream compositions. The use of the fat compositions in some applications has also been found to impart certain advantages to said compositions over those known in the art. In the case of frozen dessert compositions, certain fat compositions have surprisingly been found to impart a similar melting profile to compositions containing coconut oil, and also to have similar sensory properties such as mouthfeel, meaning that said fat compositions can be used as an effective substitute for coconut oil in non-dairy frozen dessert applications.

When used in whipping cream compositions, the certain fat compositions have been found to impart certain advantages to the compositions over analogous compositions containing partly or fully hydrogenated palm kernel oil (which can be considered to represent the state of the art for non-dairy whipped cream compositions) such as a shorter whipping time to reach maximum firmness, increased creaminess, a reduced product density, and less mouth coating. The whipping cream compositions of the invention have also surprisingly been found to have other sensory and functional properties necessary for effective use in whipping cream compositions, meaning that the fat compositions can be used as an effective replacement for fully or partially hydrogenated palm kernel oil.

In addition to the above, the certain fat compositions are advantageous over the use of tropical fats such as coconut oil, shea oil, palm kernel oil and palm oil because such certain fat compositions are derived from vegetable fats derived from vegetable sources originating from non-tropical regions of the world such as Europe and North America. The vegetable sources originating from non-tropical regions can be grown and harvested on a commercial scale in those non-tropical regions. This is especially advantageous as Europe and North America are the biggest markets for dairy analogue products.

Additionally, the certain fat compositions are free of trans unsaturated fatty acids, meaning that said compositions are considered healthier than similar compositions comprising more significant quantities of trans fatty acids such as partially hydrogenated vegetable oils. It has also been found, advantageously, that the certain fat compositions for use in the invention do not have the undesirable “waxy” mouthfeel associated with the majority of fully hydrogenated vegetable fats and oils.

Accordingly, it has thus been found that the present fat compositions, when used in dairy analogue compositions, can provide various advantages over the use of tropical fats such as coconut oil in said compositions. This is especially advantageous as the fats can be sourced from non-tropical locations which are in close proximity to major cheese analogue markets. These fat compositions also avoid the negative health implications of partially hydrogenated fats, and the undesirable sensory properties such as waxy mouthfeel of fully hydrogenated fats.

According to a first aspect of the invention, there is provided a dairy analogue composition comprising up to 90% by weight of water; and from 1% by weight to 80% by weight of a fat composition; wherein the fat composition comprises an interesterified blend of non-tropical vegetable oil and fully non-tropical hydrogenated vegetable oil.

Typically, the interesterified blend is an interesterified blend of non-tropical vegetable oil and fully hydrogenated non-tropical vegetable oil. Non-tropical vegetable oils are those for which the sources, such as seeds or sticklings, are originated from non-tropical regions of the world such as North America, parts of Northern Asia and Europe.

Preferably, the water is present in the dairy analogue composition in an amount of from 0% to 90% by weight of the dairy analogue composition, such as from 35% to 65%, from 35 to 55%, from 45 to 55% or from 50 to 65% by weight. In some embodiments, the dairy analogue composition comprises up to 80% by weight of water, including 0 wt. %, such as from 30% to 80% or from 50 to 70% by weight.

Preferably, the fat composition is present in the dairy analogue composition in an amount of from 1% to 40% by weight of the dairy analogue composition. In some embodiments, the fat composition comprises up to 100% by weight of the fat composition of the interesterified blend of vegetable oil and fully hydrogenated vegetable oil, such as up to 80%, 70%, 60%, 50%, 40% or 30% by weight.

In some embodiments, the fat composition comprises (a) from 5% to 95% by weight of the fat composition of the interesterified blend of vegetable oil and fully hydrogenated vegetable oil and (b) from 5% to 95% by weight of the fat composition of blending vegetable oil. For example, the fat composition may comprise (a) from 10% to 90% by weight of the fat composition of the interesterified blend of vegetable oil and fully hydrogenated vegetable oil and (b) from 10% to 90% by weight of the fat composition of blending vegetable oil. Preferably, the fat composition comprises (a) from 20% to 80% by weight of the fat composition of the interesterified blend of vegetable oil and fully hydrogenated vegetable oil and (b) from 20% to 80% by weight of the fat composition of blending vegetable oil. More preferably, the fat composition comprises (a) from 50% to 80% by weight of the fat composition of the interesterified blend of vegetable oil and fully hydrogenated vegetable oil and (b) from 20% to 50% by weight of the fat composition of blending vegetable oil. Most preferably, the fat composition comprises (a) from 60% to 80% by weight of the fat composition of the interesterified blend of vegetable oil and fully hydrogenated vegetable oil and (b) from 20% to 40% by weight of the fat composition of blending vegetable oil.

Typically, the interesterified blend is an interesterified blend of from 20% to 60% by weight of vegetable oil and from 40% to 80% by weight of fully hydrogenated vegetable oil. Preferably, the interesterified blend is an interesterified blend of from 40% to 60% by weight of vegetable oil and from 40% to 60% by weight of fully hydrogenated vegetable oil. More preferably, the interesterified blend is an interesterified blend of from 45% to 55% by weight of vegetable oil and from 45% to 55% by weight of fully hydrogenated vegetable oil.

In the context of the fat compositions of the invention, the term “hardstock” is used herein to refer to the interesterified blend of the fat composition (i.e. component (a) of the fat composition if a blending vegetable oil is also included).

Typically, the interesterified blend is an interesterified blend of liquid vegetable oil and fully hydrogenated vegetable oil. In some embodiments, the interesterified blend is an interesterified blend of (i) fully hydrogenated vegetable oil and (ii) vegetable oil, each vegetable oil being selected from rapeseed oil, high oleic rapeseed oil, high erucic acid rapeseed oil, soybean oil, sunflower oil, high oleic sunflower oil, linseed oil, olive oil, corn oil, cottonseed oil, carinata oil, groundnut oil, safflower oil, high oleic safflower oil, peanut oil, rice oil, camelina oil, or any combination thereof, although it will be understood that similar vegetable oils may also be used.

Preferably, the interesterified blend is an interesterified blend of (i) fully hydrogenated vegetable oil and (ii) vegetable oil, each vegetable oil being selected from rapeseed oil, high oleic rapeseed oil, high erucic acid rapeseed oil, or a combination thereof.

The term “fully hydrogenated vegetable oil” as used herein is used to refer to a vegetable oil that has undergone hydrogenation so as to convert its unsaturated fatty acid residues into saturated fatty acid residues. Suitable process conditions and methods for hydrogenating vegetable oil are known in the art. Any suitable fat hydrogenation process known in the art can be used to produce the fully hydrogenated vegetable oils of the present invention. For example, hydrogenation processes discussed in EP2196094 can be used. The term fully hydrogenated as used herein is used to distinguish the hydrogenated vegetable oils for use in producing the hardstock from partially hydrogenated vegetable oils which typically contain a significant quantity of trans fatty acid residues. In full hydrogenation, the hydrogenation process is allowed to continue to such an extent that all or substantially all of the unsaturated fatty acid residues present in the molecule are converted to saturated fatty acid residues. Accordingly, in some embodiments, the fully hydrogenated vegetable oil comprises less than 5% by weight of trans fatty acids, more preferably less than 2% by weight of trans fatty acids and most preferably less than 1% by weight of trans fatty acids, wherein said percentages of fatty acid residues refers to fatty acids bound as acyl groups in glycerides in the fully hydrogenated vegetable oil and being based on the total weight of C4 to C24 fatty acid residues bound as acyl groups present in the fully hydrogenated vegetable oil.

In some embodiments, the hardstock is derived from interesterification of a first vegetable oil and a fully hydrogenated vegetable oil that is itself derived from the first vegetable oil, although it will be understood that this is not essential. For example, in one preferred embodiment, the interesterified blend is an interesterified blend of (i) fully hydrogenated rapeseed oil and (ii) high oleic rapeseed oil.

In another preferred embodiment, the fully hydrogenated vegetable oil comprises high erucic acid rapeseed oil, or other fully hydrogenated fats with a mixed fatty acid chain length oil. In this embodiment, preferably, the interesterified blend is an interesterified blend of (i) fully hydrogenated vegetable oil; (ii) fully hydrogenated high erucic acid rapeseed oil; and (iii) vegetable oil such as rapeseed oil or high oleic rapeseed oil. Most preferably, the interesterified blend is an interesterified blend of (i) from 30% to 50% by weight of fully hydrogenated rapeseed oil; (ii) from 5% to 15% by weight of fully hydrogenated high erucic acid rapeseed oil; and (iii) from 40% to 60% by weight of vegetable oil such as rapeseed oil. Other fully hydrogenated fats with a mixed fatty acid chain length include carinata oil. Without being limited by theory, it is believed that if the fully hydrogenated vegetable oil comprises a fully hydrogenated vegetable oil with a mixed fatty acid chain length, the melting behaviour of the fat is further improved for dairy analogue compositions. Specifically, it is believed that the mixed fatty acid chain length alters the crystallisation pattern of the interesterified fat blend such that the melting behaviour is improved which can lead to improved sensory properties. This property has been found useful by the inventors in a variety of dairy analogue composition applications.

Typically, the interesterified blend comprises less than 55% by weight of saturated fatty acid residues, wherein said percentages of fatty acid residues refers to fatty acids bound as acyl groups in glycerides in the interesterified blend and being based on the total weight of C4 to C24 fatty acid residues bound as acyl groups present in the interesterified blend.

Typically, the interesterified blend comprises stearic acid residues in amount of from 40% to 60% and/or palmitic residues in an amount of 2.5% to 7.5%, wherein said percentages of fatty acid residues refers to fatty acids bound as acyl groups in glycerides in the interesterified blend and being based on the total weight of C4 to C24 fatty acid residues bound as acyl groups present in the interesterified blend.

In preferable embodiments, the fat composition comprises from 45% to 55% by weight of saturated fatty acid residues; from 30% to 40% of monounsaturated fatty acid residues; from 5% to 15% of polyunsaturated fatty acid residues; and/or less than 1% of trans unsaturated fatty acid residues; wherein said percentages of fatty acid residues refers to fatty acids bound as acyl groups in glycerides in the interesterified blend and being based on the total weight of C4 to C24 fatty acid residues bound as acyl groups present in the interesterified blend.

In preferable embodiments, the fat composition comprises from 40% to 50% by weight of C18:0; from 30% to 40% by weight of C18:1; from 5% to 12% of C18:2; from 1% to 6% of C18:3; and/or from 2.5% to 7.5% of C16:0; wherein said percentages of fatty acid residues refers to fatty acids bound as acyl groups in glycerides in the interesterified blend and being based on the total weight of C4 to C24 fatty acid residues bound as acyl groups present in the interesterified blend.

The interesterified blend is produced by interesterification of the fully hydrogenated vegetable oil and liquid vegetable oil. Typically, the interesterified blend has been produced by chemical interesterification, enzymatic interesterification, or a combination thereof. Any suitable interesterification process known in the art can be used to produce the interesterified blend. Suitable processes conditions for interesterification are known. For example, the interesterification process conditions discussed in EP2196094 can be used.

The fat composition also may comprise blending vegetable oil component (b) which is mixed with the hardstock composition. Blending vegetable oil component (b) can be any suitable vegetable oil. Typically, blending vegetable oil component (b) is a liquid vegetable oil. Typically, blending vegetable oil component (b) is a non-tropical vegetable oil. Preferably, the blending vegetable oil of (b) comprises rapeseed oil, high oleic rapeseed oil, soybean oil, sunflower oil, high oleic sunflower oil, linseed oil, olive oil, corn oil, cottonseed oil, groundnut oil, safflower oil, high oleic safflower oil, peanut oil, rice oil, camelina oil, or any combination thereof.

The term “fat” as used herein refers to glyceride fats and oils containing fatty acid acyl groups and does not imply any particular melting point. The term “oil” is used synonymously with “fat” herein.

The term “fatty acid”, as used herein, refers to straight chain saturated or unsaturated (including mono- and poly unsaturated) carboxylic acids having 8 to 24 carbon atoms. A fatty acid having x carbon atoms and y double bonds may be denoted Cx:y. For example, palmitic acid may denoted C16:0, oleic acid may denoted C18:1. Percentages of fatty acids in compositions referred to herein include acyl groups in tri-, di- and mono-glycerides present in the glycerides and are based on the total weight of C8 to C24 fatty acids. The fatty acid profile (i.e. composition) may be determined, for example, by fatty acid methyl ester analysis (FAME) using gas chromatography according to ISO 12966-2 and ISO 12966.4.

Preferably, the fat composition contains a substantially major portion of fat with very little water (i.e. the fat composition consists essentially of fat molecules). However, in some embodiments, the fat composition may contain water and be present in the form of an emulsion such as an oil-in-water emulsion or a water-in-oil emulsion, typically with a suitable emulsifier. In such embodiments, the weight percentage ranges provided above for the amount that the fat composition is present in the dairy analogue composition refers to only fat molecules present in the fat composition, and not any water present in the composition. Similarly, the weight percentages given above for the amount of water present in the dairy analogue composition refers to both water added in its own right during manufacture of the dairy analogue composition, and also to any water present in other components of the dairy analogue composition (such as water present in an emulsified fat composition), or water bound to any protein, as discussed in further detail below.

The fat composition can be present in any suitable amount in the dairy analogue compositions within the limits given above. It will be appreciated that the fat compositions are included in the dairy analogue compositions in an amount dependent upon the intended use of the dairy analogue composition.

The dairy analogue compositions of the invention may be any type of dairy analogue composition that comprises a fat. Examples of dairy analogue compositions include cheese analogue compositions, frozen dessert analogue compositions, whipping cream analogue compositions, cream, fermented products, acidified products, drinks, spread and margarine analogue compositions. Preferably, the dairy analogue compositions of the invention comprise a cheese analogue composition, a frozen dessert analogue composition, or a whipped cream analogue composition.

Cheese Analogue Compositions

In some embodiments, the dairy analogue compositions of the invention are cheese analogue compositions.

Typically, the cheese analogue compositions comprise from 15% to 30% by weight of the fat composition; from 0% to 45% by weight of a starch; from 0% to 15% by weight of non-animal protein; and from 35% to 65% by weight of water. Preferably, the fat composition is present in the cheese analogue composition in an amount of from 20% to 30% by weight. Preferably, the starch is present in the cheese analogue composition in an amount of from 1% to 45% by weight.

The cheese analogue compositions of the invention may comprise one or more non-animal proteins, such as one or more proteins derived from fungi, plants, microorganisms, or a combination thereof.

Typically, the non-animal protein comprises plant protein. Preferably, the plant protein is selected from algae protein, black bean protein, canola protein, wheat protein, chickpea protein, fava protein, lentil protein, lupin bean protein, mung bean protein, oat protein, pea protein, potato protein, rice protein, soy protein, sunflower seed protein, wheat protein, white bean protein, and protein isolates or concentrates thereof. In other embodiments, the non-animal protein comprises seitan, rice protein, mushroom protein, legume protein, tempeh, yam flour, tofu, mycoprotein, peanut flour, yuba, nuts, protein derived from nuts, nut derived milk products, or a combination thereof.

Plant protein is a source of protein which is obtained or derived from plants. The plant protein may be any suitable plant protein and may comprise a mixture of plant proteins and/or may include protein isolates or concentrates. Examples of suitable plant proteins include those discussed above. As discussed above, the weight percentage ranges referred to above for water present in the cheese analogue compositions include both water added in its own right and water present in other components of the cheese analogue composition such as in vegetable proteins or emulsified with fat. Similarly, the weight percentage ranges given below for the amount of non-animal protein present in the cheese analogue composition refer to dry weight of protein, and do not include water bound to the non-animal protein.

The plant protein used in the preparation of the cheese analogue composition may be either dry (also referred to as ‘dry phase’ herein) or moist. Thus, in embodiments, the plant protein may be included in a dry mix of ingredients, which may include additional ingredients intended for inclusion in the cheese analogue composition, such as carbohydrates, fibre and/or hydrocolloids, in addition to protein. If the plant protein is dry, it may be hydrated prior to and/or during the formation of the cheese analogue composition. The term ‘dry’ used in relation to the plant protein and ‘dry phase’ used herein, is intended to mean that the phase comprising plant protein comprises less than 5 wt. % water, preferably less than 2 wt. % water, more preferably less than 1 wt. % water, even more preferably that it is substantially free from water. In other preferred embodiments, the aw of the dry phase is 0.90 or lower, more preferably below 0.80. The dry phase comprising plant protein is typically provided in a substantially dehydrated state to reduce microbial growth as far as possible so as to extend shelf life.

If present in the cheese analogue compositions, the non-animal proteins are typically present in the cheese analogue compositions in an amount of up to 15% by weight of the cheese analogue composition. Preferably, the non-animal protein is present in an amount of 12.5% or less by weight of the cheese analogue composition, such as 10% by weight or less of the cheese analogue composition.

Cheese analogue compositions of the invention comprise one or more starches. The starches may comprise any suitable type of starch such as those starches known in the art for inclusion in cheese analogue compositions. Examples of starches that can be included include non-modified starches, modified starches, or a combination thereof. In some embodiments, the starch comprises non-modified or modified vegetable starch, rice starch, tapioca starch, wheat starch, or a combination thereof. In one embodiment, the starch comprises modified starch derived from potatoes. Preferably, the starch comprises potato starch, waxy maize starch, tapioca starch, or a combination thereof.

Specific examples of starches and modified starches that can be included in the cheese analogue compositions include a mixture of oxidised starch E1404 and starch sodium octenyl succinate E1450 where the modified starches are derived from potato starch; SIMPLISTICA™ VCP 1214 OG which comprises starch derived from potato, maize and tapioca; KaTech NDG 1098.72 which comprises potato starch and carrageenan; Perfectasol™ D500 which comprises enzymatically modified potato starch and potato protein, modified waxy maize starch (E1450); and Perfectasol™ D510 which comprises acid treated potato starch, hydroxypropylated distarch phosphate of potato origin, and pregelatinized starch sodium octenyl succinate of potato origin.

Without being limited by theory, it is believed that the starch is important for contributing to the various sensory and functional properties of the cheese analogues such as how hard or soft the cheese is, as discussed in further detail below, and also various functional properties of the cheese such as its stretchability on heating (an important function in the case of pizza cheese), and sliceabillity. The starches are believed to help aid in providing the effects provided by casein in dairy cheeses, such as providing the requisite properties for various different applications.

The starches are preferably present in the cheese analogue composition in an amount of from 1% to 45% by weight of the cheese analogue composition, such as 5% to 40% by weight. Typically, the starch is present in an amount of from 20% to 30% by weight of the cheese analogue composition.

As discussed above, if the cheese analogue compositions contain protein, the protein is typically present in the compositions in amount of up to 15% by weight of the cheese analogue compositions.

Typically, the combined weight percent of starch and non-animal protein in the cheese analogue compositions does not exceed 45%. Preferably, the combined weight percent of starch and non-animal protein in the cheese analogue composition is less than 35% and preferably from 20% to 30%. In these embodiments, the non-animal protein is typically present in an amount of less than 12.5% by weight of the cheese analogue composition such as from 5% to 12.5%, or from 5% to 10% by weight of the cheese analogue composition, although it will be appreciated that even less protein may be present, or in some embodiments protein may be completely omitted from the compositions.

In this respect, when protein is included in the cheese analogue compositions, the protein included is used as a replacement for starch, since the combined amount of protein and starch does not exceed the limits discussed above. The protein may also carry out the same role as starch discussed above in the cheese analogue compositions.

The cheese-analogue composition comprises water, which may be added as a separate component to the composition, or derive from other components of the composition as discussed above. The amount of water is not particularly limited and, as the skilled person will appreciate, will vary depending on the intended consistency of the cheese-analogue composition, as discussed in further detail below. Reference to ‘water’ herein is intended to include drinking water, demineralized water or distilled water, unless specifically indicated. Preferably, the water employed in connection with the present invention is demineralised or distilled water. As the skilled person will appreciate, deionized water is also a sub-class of demineralized water. In some embodiments, water may be added to the composition where the water is a condensate from steam used to heat the various components or combination of components of the cheese analogue composition during manufacture.

The cheese analogue composition typically comprises one or more additional ingredients. Whilst these one or more additional ingredients may be preferable to include in the cheese analogue compositions, it will be understood that the inclusion of the one or more additional ingredients is not essential.

Preferably, the cheese analogue composition comprises one or more flavouring additives, preferably wherein the one or more flavouring additives are present in an amount of from 0.1% to 5% by weight of the cheese analogue composition.

Preferably, the cheese analogue composition comprises one or more colouring additives, preferably wherein the one or more colouring additives are present in an amount of from 0.01% to 1% by weight of the cheese analogue composition.

In some embodiments, the cheese analogue composition further comprises one or more of: i) polysaccharides and/or modified polysaccharides, preferably selected from methylcellulose, hydroxypropyl methylcellulose, carboxymethyl cellulose, maltodextrin, carrageenan and salts thereof, alginic acid and salts thereof, agar, agarose, agaropectin, pectin and alginate; ii) hydrocolloids; and iii) gums, preferably selected from xanthan gum, guar gum, locust bean gum, gellan gum, gum arabic, vegetable gum, tara gum, tragacanth gum, konjac gum, fenugreekgum, and gum karaya.

Examples of other additives that may be included in the cheese analogue compositions include an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, salt, spices, fibre, thickening and gelling agents, egg powder, enzymes, gluten, vitamins, preservatives, sweeteners, oxidising agents, reducing agents, anti-oxidants, acidity regulators, or combinations thereof.

The specific properties of the cheese analogue compositions may be tailored by controlling the relative amounts of the fat composition, water, starch, and protein (if present), in the compositions. The properties of the cheese analogue composition may be tailored and optimised so as to provide different types of cheese analogue compositions. For example, there are many types of cheese analogue compositions in existence with very different properties. As will be appreciated by the skilled person, different properties are desirable for different applications. For example, a spreadable cheese (such as a cream cheese analogue) will desirably be soft and spreadable and have very different properties than for example a parmesan cheese analogue which will desirably be hard but grateable into small particles, or sandwich cheese which must be more resilient but easily sliceable. Other properties that the cheese analogue may be desirable to have include stretchiness at elevated temperature such as mozzarella pizza cheese analogues.

When optimising and tailoring the physical properties of a particular cheese analogue, typically, the weight percentage of the fat composition in the cheese analogue composition will remain similar between the different types of cheese analogue. For example, both cream cheese and hard cheese would typically contain similar amounts of the fat composition, such as in an amount of from 15% to 30% by weight of the cheese analogue composition. In contrast, the water content of the cheese analogue compositions and the combined protein and starch content of the compositions are typically varied and optimised for providing different sorts of cheese compositions. Typically, for harder cheese analogue compositions, the compositions contain a relatively lower water content and a relatively higher combined protein and starch content. The opposite is the case for softer cheese. Spreadable cheeses such as cream cheese analogues will have the highest water content and lowest relative combined starch and protein content.

In some embodiments, the cheese analogue composition comprises from 35% to 55% by weight of water; and wherein the combined weight percent of starch and non-animal protein in the cheese analogue composition is from 25% to 35%. Typically, the fat composition will be present in an amount of from 15% to 30% by weight of the composition. Typically, such cheeses will have the desired properties of harder cheeses and the cheese analogue compositions will be compositions such as a cheddar cheese, parmesan cheese, pizza type cheese, sandwich cheese, or similar-type cheese analogue compositions.

In other embodiments, the cheese analogue composition comprises from 45% to 55% by weight of water; and wherein the combined weight percent of starch and non-animal protein in the cheese analogue composition is from 20% to 35%. Typically, the fat composition will be present in an amount of from 15% to 30% by weight of the composition. Typically, such cheeses will have the desired properties of softer cheeses and the cheese analogue composition will be a brie or brie-type cheese, feta cheese, or similar-type cheese analogue composition.

In other embodiments, the cheese analogue composition comprises from 50% to 65% by weight of water; and wherein the combined weight percent of starch and non-animal protein in the cheese analogue composition is from 5% to 25%. Typically, the fat composition will be present in an amount of from 15% to 30% by weight of the composition. Typically, such cheeses will have the desired properties of spreadable cheeses such as cream cheeses and the like, and the cheese analogue compositions will be spreadable cheese analogue compositions.

As discussed above, surprisingly, it has been found that the fat compositions described herein are suitable for use in all of the different types of cheese analogue composition discussed above, and can provide the desired properties of each type of cheese analogue. This is in contrast to certain fats known in the art for use in cheese analogue compositions that can provide the desired properties for only some types of cheese analogue compositions, but not others.

In other embodiments, the fat composition has a solid fat content (SFC) N10 of less than 60, measured on unstabilised fat according to ISO 8292-1, preferably, wherein the fat composition has a solid fat content (SFC) N10 of from 50 to 60, measured on unstabilised fat according to ISO 8292-1.

In each of the different types of cheese analogue compositions, such as the different types of cheese analogue compositions discussed above, it is often desirable to tailor and optimise the nature of the fat composition so that it is most appropriate for the specific type of cheese analogue composition. In particular, it is often desirable to tailor the solid fat content of the cheese composition at 10° C. for the different types of compositions. Typically, harder cheese analogue compositions will desirably have higher solid fat contents at 10° C. than softer cheese analogue compositions such as brie-type cheeses. Spreadable cheese analogue compositions such as cream cheese analogues will desirably have even lower solid fat contents at 10° C. 10° C. is a typical temperature at which cheese analogue compositions will be when taken out of a fridge. The solid fat content is believed to affect various properties of the cheese analogue compositions such as its hardness and spreadability. Typically, a lower solid content at 10° C. will result in a softer composition with increased spreadability, and vice versa for a higher solid fat content. Typically, the solid fat content at 10° C. may be tailored by tailoring the chemical characteristics of the fat. For example, having a higher saturated fat content may increase the solid fat content of the fat at 10° C. The specific fat compositions for inclusion in the cheese analogue compositions can be any of those discussed above. Preferably the fat compositions for inclusion in cheese analogue compositions are those that comprise both the hard stock component (a) and blending vegetable oil component (b).

Frozen Dessert Compositions

In some embodiments, the dairy analogue composition comprises a frozen dessert analogue composition.

Typically, the frozen dessert analogue compositions comprise from 1% to 20% by weight of the fat composition; from 10% to 40% by weight sugar; and from 30% to 80% by weight of water. Preferably, the frozen dessert analogue composition comprises from 50% to 70% by weight of water, from 1% to 10% by weight of the fat composition; and from 20% to 35% by weight sugar.

The specific fat compositions for inclusion in the frozen dessert analogue compositions can be any of those discussed above. Preferably the fat compositions for inclusion in frozen dessert analogue compositions are those that comprise both the hard stock component (a) and blending vegetable oil component (b).

Examples of frozen dessert analogue compositions include non-dairy ice cream compositions. In some embodiments, the frozen dessert analogue composition is a vegan ice cream composition being free of dairy fats and also other animal derived material such as animal derived proteins such as casein. Whilst preferred, the frozen dessert analogue compositions of the invention are not limited to ice cream compositions, and may be any frozen dessert composition that contains fat.

The term frozen as used herein refers to products that are solidified under freezing conditions. The ice content of the frozen confection should be more than 15% but less than 45% when measured at −18° C. The frozen confection is preferably a water-continuous emulsion.

The frozen confection of the invention is preferably aerated, i.e., it has an overrun of more than 20 percent and preferably less than 200%. Most preferably the product is a product having an overrun of from 20-100%. Overrun is defined by the following equation and is measured at atmospheric pressure: Overrun %=((density of mix−density of frozen confection)/density of frozen confection)×100.

The frozen dessert composition preferably comprises protein, optionally wherein the protein is present in the dairy analogue composition in an amount of from 0.1% to 10% by weight of the composition; preferably wherein the protein is a non-animal protein. Any suitable protein may be used such as those discussed above. Particular types of protein that can be used include pea protein, chickpea protein, soy protein, rice protein, potato protein, and wheat protein.

The frozen dessert composition may comprise solids derived from nuts or fruit, which are typically present in an amount of from 1% to 10% by weight of the composition. Sources for nut solids include almonds, cashews, pecans, peanuts, macadamia nuts, brazil nuts, pine nuts, coconuts, butternuts, hazelnuts, walnuts, beechnuts, hickory nuts, chestnuts, pistachios, and mixtures thereof, although it will be understood that any suitable solids derived from nuts or fruit may be included.

The frozen dessert compositions may comprise one or more sugars. Typically, the sugars are present in an amount of from 10% to 40% by weight of the composition. Sources of sugar include corn syrup, glucose syrup, glucose, fructose, sucrose, maltose, galactose, dextrin, or a combination thereof, although it will be understood that other similar sugars and sources of sugar may be included in the compositions.

Typically, the frozen dessert compositions comprise one or more emulsifiers, which one or more emulsifiers are typically present in an amount of up to 1% by weight of the dairy analogue composition. Examples of emulsifiers that can be used include proteins and phospholipids such as lecithin and mono- and diglycerides.

Typically, the frozen dessert compositions further comprise one or more hydrocolloid stabilisers, wherein the one or more hydrocolloid stabilisers are typically present in an amount of up to 1% by weight of the dairy analogue composition. Examples of hydrocolloid stabilisers include gums such as guar gum and locust bean gum and alginate and carrageenan. Stabilisers are useful so as to ensure adequate properties of the composition such as suitable aeration, mouth feel and viscosity as well as provide stability to the composition.

In some embodiments, the frozen dessert composition further comprises an animal milk-derived protein, preferably wherein the animal-milk derived protein comprises casein.

Other additives that can be included will be familiar to the skilled person and include preservatives, sweeteners, salts, bulking agents, flavourings, and inclusions such as nut pieces, fruit pieces, chocolate and biscuit pieces etc.

Whipped Cream Compositions

The compositions of the invention may be whipping cream analogue compositions such as non-dairy whipping cream compositions.

Typically, the whipping cream compositions comprise from 1% to 40% by weight of the fat composition and up to 80% by weight of water. Preferably, the whipping cream analogue composition comprises from 4% to 35% by weight of the fat composition.

The specific fat compositions for inclusion in the whipped cream analogue compositions can be any of those discussed above. Preferably the fat compositions for inclusion in whipped cream analogue compositions are those comprise only the hard stock component (a) and not the vegetable oil component (b).

The whipping cream compositions may further comprise protein, such as non-animal protein. When included, the protein is preferably present in the whipping cream analogue composition in an amount of from 0.1% to 5% by weight of the composition. In alternative embodiments, the whipping cream compositions may be free of protein.

The whipping cream compositions typically comprise one or more emulsifiers. Preferably the one or more emulsifiers are present in an amount of up to 1% by weight of the dairy analogue composition. Any suitable emulsifier may be included. For example, an anionic emulsifier may be included such as sodium steroyl lactylate, diacetyltartaric acid esters of monoglycerides or diglycerides, polyglycerol esters of fatty acids, polysorbates, monoglycerides, mono-diglycerides, lactic acid esters of mono and diglycerides, lecithins, sorbitan monostearates, or combinations thereof. Such emulsifiers are often important in contributing to the whipping properties of the whipped cream compositions.

The whipping cream compositions typically comprise one or more hydrocolloid stabilisers. Preferably, the one or more hydrocolloid stabilisers are present in the compositions in an amount of up to 1% by weight of the dairy analogue composition. Hydrocolloid stabilisers may be added to the compositions to further improve the stability of the whipped cream and improve whipping properties such as overrun and foam firmness. Hydrocolloid stabilisers may be particularly desirable when the whipping cream compositions are free of protein. Examples of suitable hydrocolloid stabilisers include cellulose ether products such as methyl cellulose, hydroxypropylmethyl cellulose and hydroxypropyl cellulose.

The term whipping cream as used herein is used to refer to an oil-in-water emulsion, which can be aerated by whipping, whereby fat globules collide and partially coalesce, forming aggregates or clusters that stabilise the foam structure.

The whipping cream compositions may include additional additives such as sugars, sweeteners, bulking agents, flavourings, salts, and other additives known in the art for inclusion in such compositions.

In some embodiments, the whipped cream analogue composition further comprises an animal milk-derived protein, preferably wherein the animal-milk derived protein comprises casein.

The whipped cream compositions can be used in any suitable application known in the art such as dessert toppings or accompaniments or ice cream.

In preferable embodiments, the dairy analogue compositions of the invention are suitable for consumption by vegetarians and vegans. Accordingly, in preferable embodiments, the dairy analogue compositions are substantially free of animal protein, and more preferably, the dairy analogue compositions are free of animal protein.

In preferable embodiments, the dairy analogue composition is substantially free of animal-derived products, and more preferably, the dairy analogue composition is free of animal-derived products.

However, in some embodiments, the dairy analogue compositions may comprise animal-derived products such as animal derived proteins or fats. Accordingly, in some embodiments, the dairy analogue composition further comprises one or more animal-derived products such as animal oils, marine oils, animal-derived proteins, animal-derived polysaccharides, or any combination thereof. In some embodiments, the one or more animal-derived products comprise animal milk proteins, animal milk fats, or a combination thereof. In these embodiments, the dairy analogue compositions may be suitable for consumption by vegetarians on the basis that they comprise non-animal protein and proteins or fats derived from animal milk. These dairy analogue compositions are suitable for consumption by vegetarians since they do not include fats or proteins derived from meat. However, it will of course be understood that such dairy analogue compositions are not suitable for consumption by vegans.

In embodiments where the dairy analogue compositions comprise one or more animal-derived products, the one or more animal-derived products are typically present in the dairy analogue composition in an amount of from 0.1% to 20% by weight of the dairy analogue composition.

According to a second aspect of the invention, there is provided a food product comprising a dairy analogue composition according to the first aspect of the invention.

Preferably, the food product is a vegetarian or vegan dairy substitute food product such as a vegan or vegetarian cheese substitute, frozen dessert substitute, plant based dairy analogue drink, plant based dairy analogue powder, ghee, fermented product, yellow fat, spread, or whipping cream substitute food product.

In some embodiments, the food product comprises a cheese analogue food product. The food product can be any cheese analogue composition food product, or food product comprising the cheese analogue compositions of the invention. The cheese analogue compositions of the invention can be provided as any type of cheese analogue composition food product. Preferably, the food product comprises a pizza cheese, a sandwich cheese, a feta cheese, a soft spreadable cheese, or a hard cheese; more preferably wherein the food product comprises a pizza cheese, a sandwich cheese, or a feta cheese.

In other embodiments, the food product is a whipped cream food product or whipped cream containing food product such as a dessert topped or accompanied by whipped cream.

In other embodiments, the food product is a frozen dessert food product such as an ice cream or sorbet food product. Typically, the food product is a non-dairy ice cream food product.

The properties of the dairy-analogue composition or food products prepared using the composition may be measured by any suitable means. Properties of interest may include hardness, adhesiveness, springiness, cohesiveness, mouth feel, coldness, iciness, rate of melt, smoothness, creaminess, mouthcoating, sweetness, flavour and resilience. Such means include taste testers, which can provide feedback on properties of the composition or food product such as juiciness (or dryness), texture, chewiness and hardness. Typically multiple testers will be asked to mark one or more properties of the composition or food product, such as on a scale from 1 to 15. If multiple testers are asked, an average of the results can be taken to observe the general impression of the food product.

Properties of the composition or food product may also be measured using specialised equipment. For example, texture profile analysis (TPA) is a technique used to characterize textural attributes of solid and semisolid materials and may be used to determine the hardness, adhesiveness, springiness, cohesiveness, gumminess, chewiness and resilience. In this technique, the test material may be compressed two times in a reciprocating motion, mimicking the chewing movement in the mouth, producing a Force versus Time (and/or distance) graph, from which the above information can be obtained. TPA and the classification of textural characteristics is described further in Bourne M. C., Food Technol., 1978, 32 (7), 62-66 and Trinh T. and Glasgow S., ‘On the texture profile analysis test’, Conference Paper, Conference: Chemeca 2012, Wellington, New Zealand, and may be performed as described therein.

The Force versus Time (and/or distance) graph typically includes two peaks in force, corresponding to the two compressions, separated by a trough. Force may be measured in gravitational force equivalent (g-force, g) or Newtons (N).

Hardness (g or N) is defined as the maximum peak force experienced during the first compression cycle.

Adhesiveness is defined as the negative force area for the first bite, i.e. the area of the graph between the two peaks in force which is at or below a force of 0 g or N. This represents the work required to overcome the attractive forces between the surface of a food and the surface of other materials with which the food comes into contact, i.e. the total force necessary to pull the compression plunger away from the sample. For materials with a high adhesiveness and low cohesiveness, when tested, part of the sample is likely to adhere to the probe on the upward stroke. Lifting of the sample from the base of the testing platform should, if possible, be avoided as the weight of the sample on the probe would become part of the adhesiveness value. In certain cases, gluing of the sample to the base of a disposable platform has been advised but is not applicable for all samples.

Springiness, also known as elasticity, is related to the height that the food recovers during the time that elapses between the end of a first compression and the start of a second compression. During the first compression, the time from the beginning of the compression at force=0 g or N to the first peak in force is measured (referred to as ‘Cycle 1 Duration’). During the second cycle, the time from the beginning of the second compression at force=0 g or N to the second peak in force is measured (referred to as ‘Cycle 2 Duration’). Springiness is calculated as the ratio of these values, i.e. ‘Cycle 2 Duration’/‘Cycle 1 Duration’.

Cohesiveness is defined as the ratio of the positive force area, i.e. the area under the curve above a force of 0 g or N, during the second compression to that during the first compression. Cohesiveness may be measured as the rate at which the material disintegrates under mechanical action. Tensile strength is a manifestation of cohesiveness. If adhesiveness is low compared with cohesiveness then the probe is likely to remain clean as the product has the ability to hold together. Cohesiveness is usually tested in terms of the secondary parameters brittleness, chewiness and gumminess.

Resilience is a measurement of how the sample recovers from deformation both in terms of speed and forces derived. It is taken as the ratio of areas from the first probe reversal point, i.e. the point of maximum force, to the crossing of the x-axis, i.e. at 0 g or N, and the area produced from the first compression cycle between the start of compression and the point of maximum force. In order to obtain a meaningful value of this parameter, a relatively slow test speed should be selected that allows the sample to recover, if the sample possesses this property.

According to a third aspect of the invention, there is provided the use of a fat composition in a dairy analogue composition, wherein the fat composition comprises an interesterified blend of vegetable oil and fully hydrogenated vegetable oil.

Preferably, the use comprises using the dairy analogue composition in a food product.

Preferably, the dairy analogue composition, fat composition, and/or food product are as described above in accordance with the first and second aspects of the invention.

Preferably, the use comprises using the fat composition to improve the nutritional profile of the dairy analogue composition when compared to an analogous dairy analogue composition comprising the same amount by weight of coconut oil or palm kernel oil.

The term analogous dairy analogue composition as used herein is used to refer to an equivalent weight of a dairy analogue composition that is identical to the dairy analogue composition of the invention, with the exception of the nature of the fat present therein. The analogous dairy analogue composition contains the same amount by weight of coconut oil or palm kernel oil as the dairy analogue composition of the invention contains the fat composition. The nutritional profile of the dairy analogue composition of the invention may be improved in comparison to coconut oil or palm kernel oil since it contains a lower total amount of saturated fatty acid residues per unit weight than coconut oil and palm kernel oil. Coconut oil contains around 90% saturated fatty acid residues. Without being limited by theory, it is believed that fats with higher saturated fatty acid contents increase the risk of heart disease, high blood pressure and associated conditions, and also have an unfavourable effect upon the cholesterol levels of consumers.

The use may comprise using the fat composition to provide delayed release of flavours from the dairy analogue composition when consumed when compared to an analogous dairy analogue composition comprising the same amount by weight of coconut oil. Without being limited by theory, the delayed release of flavours compared to coconut oil is believed to be due to the fat compositions having a higher solid fat content than coconut oil at mouth temperatures of from 30° C. to 35° C. Many flavour and flavouring additive compounds are fat soluble and so are dissolved within the fat of the dairy analogue composition. With a higher solid fat content, the release of the dissolved flavours from the fat is delayed over a longer period of time. In the case of cheese analogues, the delayed release of flavours is believed to enable the cheese analogue composition to more closely resemble the mouth feel and delayed flavour release of cheese, which contains higher melting point fats which typically have higher solid fat contents at mouth temperature.

Surprisingly, it has been found that when the dairy analogue is a cheese analogue composition, the fat composition has been found to provide similar sensory and functional properties to coconut oil. This means that the fat compositions could be used to replace coconut oil in a variety of different types of cheese analogue composition without any compromise being made to consumer perception of the composition. Examples of such properties include sensory properties like hardness, adhesiveness, cohesiveness, resilience and springiness; functional behavior like ability to slice, ability to handle sliced cheese, ability to handle shredded cheese, ability for the cheese to stretch when heated (for example in pizza applications), reduction of waste during slicing, reduction of waste during shredding, improved quality of sliced cheese and improved quality of shredded cheese; or any combination of these properties. Additionally, the certain fat compositions have been found suitable to replace coconut oil in a variety of different types of cheese analogue composition. This is a surprising and useful benefit.

Preferably, the one or more sensory properties comprise hardness, adhesiveness, cohesiveness, resilience, springiness, or a combination thereof.

In embodiments where the dairy analogue composition comprises a frozen dessert analogue composition, it has surprisingly been found that the fat compositions impart similar desirable properties to the frozen dessert compositions as provided by coconut oil in commercially available non-dairy frozen dessert compositions. For example, it has been found that the frozen dessert compositions of the invention have a similar melt profile to analogous compositions containing coconut oil. The compositions of the invention have also been found to provide similar sensory properties when consumed to analogous compositions containing coconut oil.

In embodiments where the dairy analogue composition comprises a whipping cream composition, it has surprisingly been found that the fat compositions impart similar desirable properties to the whipping cream compositions as imparted by partially or fully hydrogenated palm kernel oil to commercially available non-dairy whipping cream compositions. In some embodiments, the use may comprise using the fat composition to provide an increased creaminess, a reduced product density, and/or less mouth coating relative to an analogous whipping cream composition comprising the same amount by weight of fully or partially hydrogenated palm kernel oil.

The use may also comprise using the fat composition to reduce the whipping time of the whipping cream composition, relative to an analogous whipping cream composition comprising the same amount by weight of fully or partially hydrogenated palm kernel oil. In these embodiments, preferably, the fully hydrogenated vegetable oil of the interesterified blend (b) comprises a mixed fatty acid chain length vegetable oil such as high erucic acid vegetable oil. It has been found that when such a fat composition is used, the whipping time of the whipping cream composition is advantageously reduced.

According to a fourth aspect of the invention, there is provided a process of manufacturing a dairy analogue composition according to the first aspect of the invention, or a food product according to the second aspect of the invention, wherein the process comprises combining a fat composition as described herein with water, and optionally, one or more additional components to form the dairy analogue composition, and optionally forming the dairy analogue composition into food products.

Suitable processes for forming the dairy analogue compositions described herein include those known in the art already for the formation of said compositions.

In embodiments where the dairy analogue composition is a cheese analogue composition, typically, the process comprises combining a fat composition as described herein, water, starch, and optionally non-animal protein and/or one or more additional components to form the cheese analogue composition, and optionally forming the cheese analogue composition into food products. In some embodiments, the process comprises combining the ingredients at a temperature of from 60° C. to 95° C.; preferably from 70° C. to 85° C., and more preferably from 75° C. to 80° C. At such temperatures, the fat compositions will melt and be able to be mixed intimately and uniformly with the water, starch and protein and other components if present so as to form a uniform system. The components can be mixed with each other in any suitable order, as will be appreciated by those skilled in the art. On combining, the ingredients of the composition are typically mixed with a shear mixer. Typically, a higher shear is used to mix the ingredients when the cheese analogue composition is a softer composition such as a cream cheese or other spreadable cheese analogue composition. A relatively lower shear is typically used for harder cheese analogue compositions. Whilst the above described steps are preferable steps for manufacturing the cheese analogue compositions or food products described herein, it will be appreciated that other suitable processes may also be used to manufacture the cheese analogue compositions and food products.

### DESCRIPTION OF THE DRAWINGS

FIG. 1 depicts the firmness of various cheese analogue compositions of the invention and a comparative cheese analogue composition comprising coconut oil.

FIG. 2 depicts the results of a sensory evaluation of various cheese analogue compositions of the invention and a comparative cheese analogue composition comprising coconut oil.

FIG. 3 depicts the melting profile of various frozen dessert compositions of the invention and a comparative frozen dessert analogue composition comprising coconut oil.

FIG. 4 depicts photographs of various frozen dessert compositions of the invention and a comparative frozen dessert analogue composition comprising coconut oil after different periods of time.

FIG. 5 depicts the results of a sensory evaluation of various frozen dessert analogue compositions of the invention and a comparative frozen dessert analogue composition comprising coconut oil.

FIG. 6 depicts photographs of whipped cream compositions of the invention and a comparative whipped cream composition comprising fully hydrogenated palm kernel oil. The photographs also show the overruns of the compositions.

FIG. 7 depicts a graph of the whipping time to achieve maximum firmness for two whipping cream compositions of the invention and a comparative whipping cream composition comprising fully hydrogenated palm kernel oil.

FIG. 8 shows the results of a sensory evaluation of two whipping cream compositions of the invention, and one comparative whipping cream composition comprising fully hydrogenated palm kernel oil.

### DETAILED DESCRIPTION OF THE INVENTION

The following examples are for illustrative purposes only, and are not intended to limit the scope of the invention in any way.

### Example 1

Two hard stock blends were manufactured as follows.

Hard stock XP 6523: formed by interesterification of a blend of 50% by weight rapeseed oil; 40% by weight fully hydrogenated rapeseed oil; and 10% by weight fully hydrogenated high erucic acid rapeseed oil.

Hard stock XP6320: formed by interesterification of a blend of 50% rapeseed oil and 50% fully hydrogenated rapeseed oil.

The hard stock blends were mixed with rapeseed oil in the amounts shown in Table 1 below to provide fat compositions.

TABLE 1

| | | Blend (% given |
|---|---|---|
| | | is percentage by |
| | | weight of the |
| # | Reference | fat composition) |
| A | XP 6540 | 60% XP 6523 and |
| | | 40% Rapeseed Oil |
| B | XP 6541 | 80% XP 6523 and |
| | | 20% Rapeseed Oil |
| C | XP 6594 | 60% XP 6320 and |
| | | 40% Rapeseed Oil |
| D | XP 6595 | 80% XP 6320 and |
| | | 20% Rapeseed Oil |
| E | Coconut | Industry standard |
| | oil (CNO) | control |

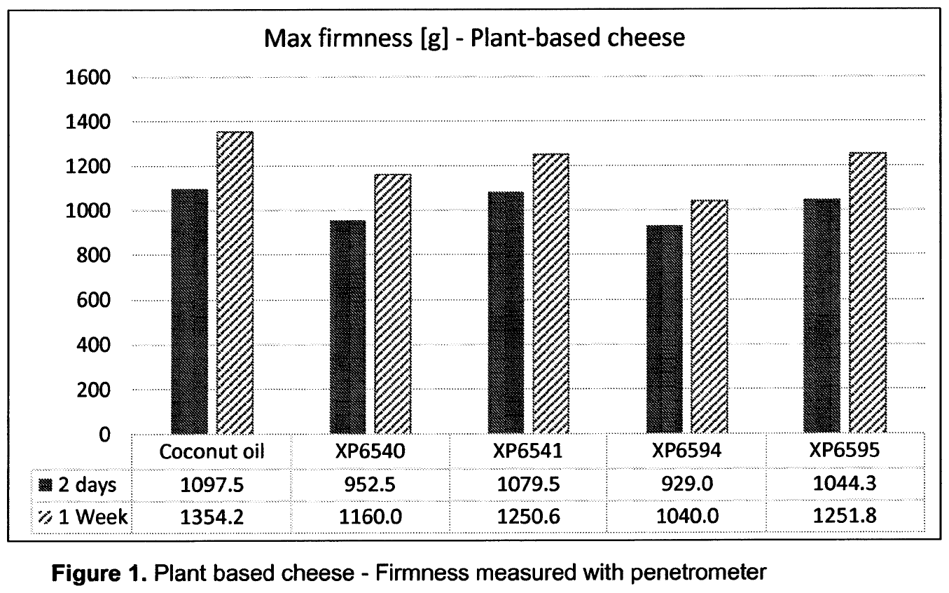

Cheese analogue compositions of the invention were manufactured comprising each of fat compositions A to D and a comparative cheese analogue composition comprising fat E was also manufactured. The firmness of the cheese analogue compositions was measured using a penetrometer. For each composition, the firmness after two days and one week was measured. The results for compositions A to E are shown in FIG. 1.

The results shown in FIG. 1 show that after 2 days, all compositions of the invention had a lower firmness than the comparative composition containing coconut oil. The results in FIG. 1 also show that after one week, the comparative cheese analogue composition containing coconut oil had the highest hardness, and also the highest increase in hardness between two days and one week. A lower hardness is desirable since it is believed to be linked to an improved mouth feel of the cheese and also a reduced crumbling and production of fines when cut or processed. Accordingly, these cheese analogue compositions of the invention show improvement in desirable properties over state of the art cheese analogue compositions containing coconut oil.

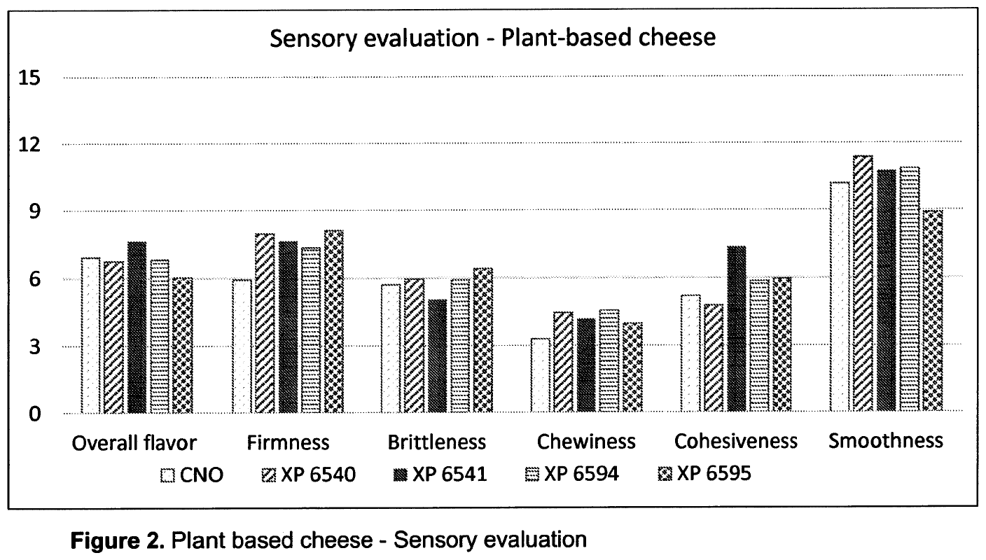

The cheeses were all subjected to a sensory evaluation by 7 panelists. The results of this sensory evaluation are shown in FIG. 2. It can be seen that the cheeses of the invention compared comparably to the comparative cheese containing coconut oil in the sensory evaluation. The conclusion of the panel was that no significant differences in sensation between the cheeses was detected, indicating that cheese analogue compositions of the invention could be an effective replacement for cheese analogue compositions known in the art containing coconut oil.

### Example 2

The same hard stocks and fat compositions as described above in Example 1 and Table 1 were manufactured.

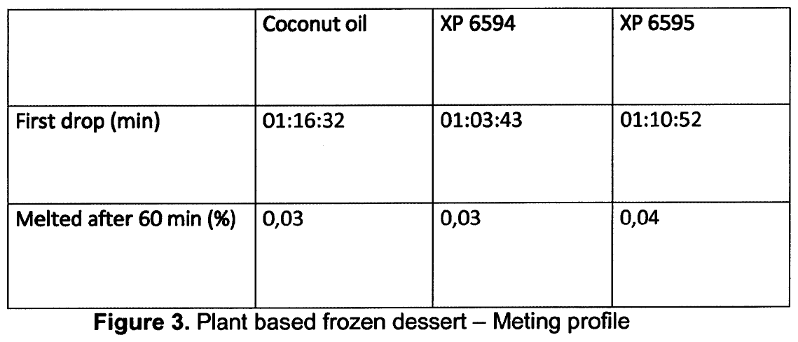

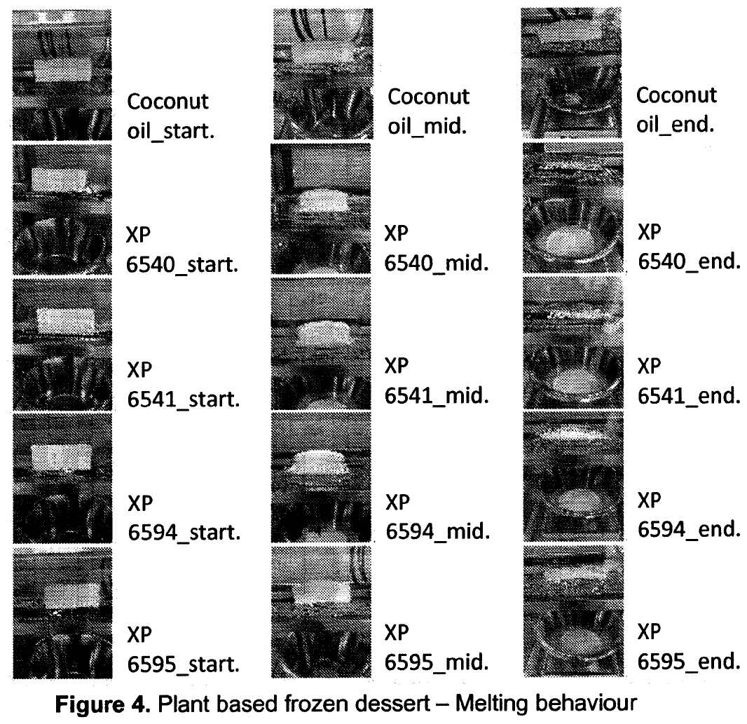

This time, four frozen dessert compositions of the invention were manufactured using the fat compositions and compared to a comparative frozen dessert composition comprising the same amount by weight of coconut oil. The melting profile of the compositions were tested, the results of which are shown in FIGS. 3 and 4.

In FIGS. 3 and 4, it can be seen that each composition of the invention has a similar melting profile to the comparative composition comprising coconut oil.

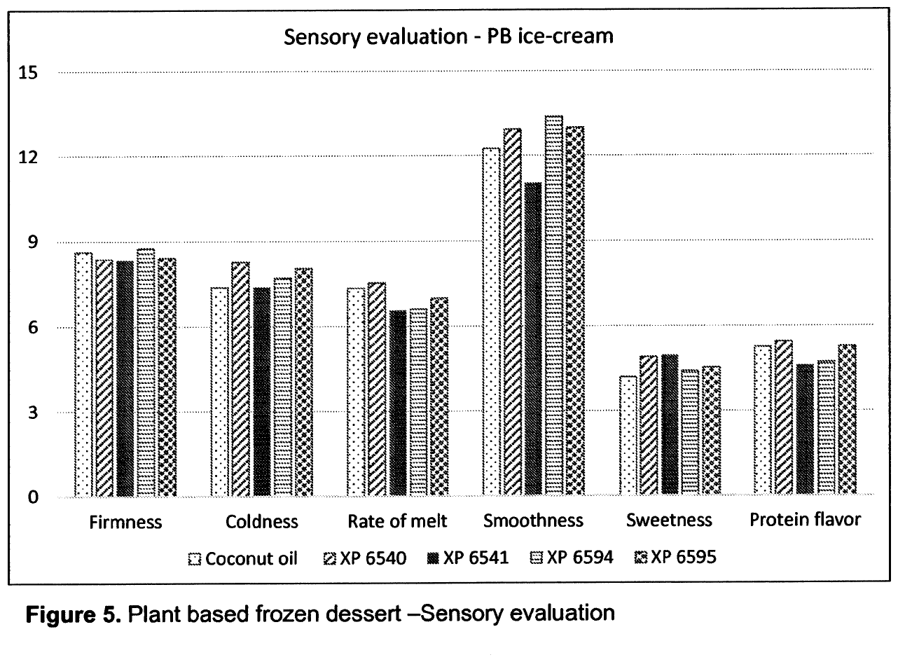

The compositions were also subjected to a sensory evaluation, the results of which are shown in FIG. 5. The results show that for a variety of different attributes, the compositions of the invention scored similarly to the comparative composition comprising coconut oil.

The results indicate that the compositions of the invention could be used as an effective substitute for coconut oil in frozen dessert compositions.

### Example 3

Two hard stock blends were manufactured as follows.

Hard stock XP 6523: formed by interesterification of a blend of 50% by weight rapeseed oil; 40% by weight fully hydrogenated rapeseed oil; and 10% by weight fully hydrogenated high erucic acid rapeseed oil.

Hard stock XP 6320: formed by interesterification of a blend of 50% rapeseed oil and 50% fully hydrogenated rapeseed oil.

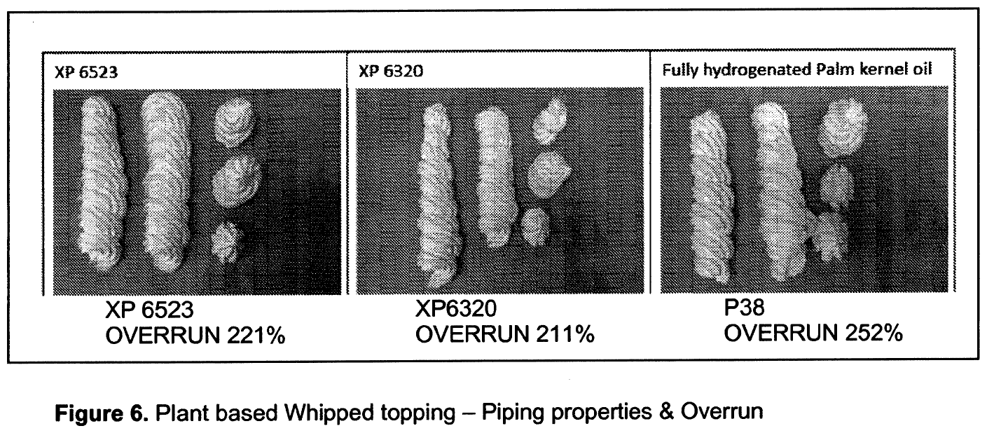

Whipping cream compositions of the invention comprising the hard stock fat compositions were then prepared. A comparative whipping cream composition comprising fully hydrogenated palm kernel oil (PKO) was also prepared. The compositions were whipped so as to form whipped cream foam. Photographs of each of the compositions are shown in FIG. 6. Various properties of the compositions are shown in Table 2 below.

TABLE 2
Overrun (%):

| | Overrun at | Overrun after 60 s |
|---|---|---|
| Sample | Max firmness | whipping time |
| FH PKO | 252 | 223 |
| XP 6523 | 211 | 200 |
| XP 6320 | 221 | 212 |

The results in table 2 show that a similar overrun was obtained for FH PKO compared to the two compositions of the invention (see FIG. 6).

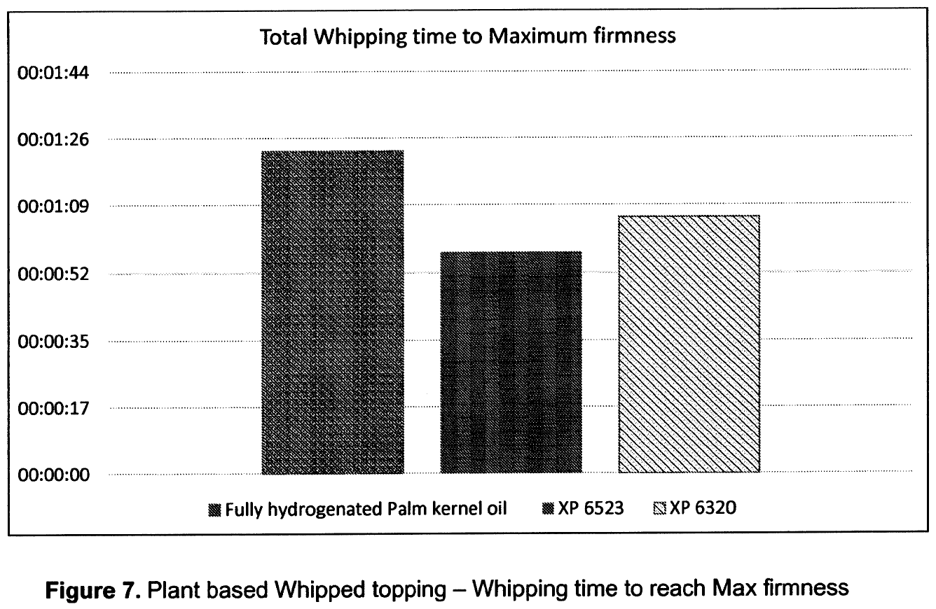

FIG. 7 shows how the firmness of each composition develops over time upon whipping. In FIG. 7, composition 1 contains the FH PKO and compositions 2 and 3 are the compositions of the invention. It can be seen that the FH PKO composition has a considerably higher maximum firmness.

It can also be observed that the compositions of the invention desirably had a faster whipping time than the comparative FH PKO composition. The XP 6523 composition had the fastest whipping time of the compositions.

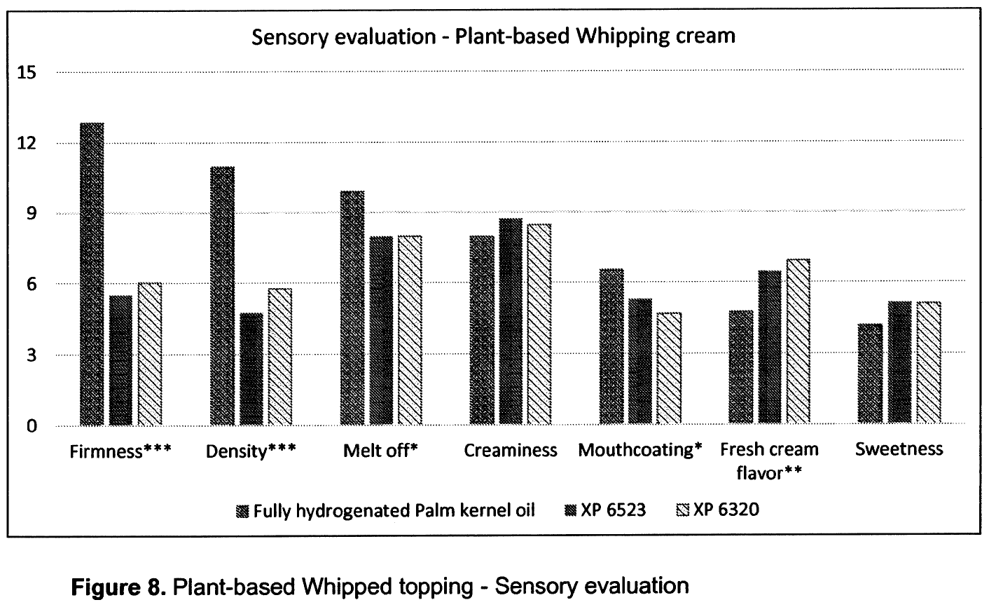

The three compositions were subjected to a sensory evaluation, the results of which are depicted in FIG. 8. For the evaluation, the three compositions were whipped for 60 seconds each.

The * indicate that a statistical difference was observed between the different formulations for the particular characteristics (the more *, the more statistical difference). It can be seen that the compositions of the invention had a much lower firmness and density than the fully hydrogenated palm kernel oil composition. This is advantageous in certain scenarios. The FH PKO composition was considered to be overwhipped and undesirably overly firm. The compositions of the invention also had a better fresh cream flavour than the FH PKO compositions.

The results of the sensory evaluation and tests indicate that the compositions of the invention could be used as an effective substitute for FH PKO in whipping cream compositions.

1. A dairy analogue composition comprising up to 90% by weight of water; and from 1% by weight to 80% by weight of a fat composition; wherein the fat composition comprises an interesterified blend of non-tropical vegetable oil and fully hydrogenated non-tropical vegetable oil.

2. A dairy analogue composition according to claim 1, wherein the fat composition is present in the dairy analogue composition in an amount of from 1% to 40% by weight of the dairy analogue composition.

3. A dairy analogue composition according to claim 1, wherein the fat composition comprises (a) from 5% to 95% by weight of the fat composition of the interesterified blend of vegetable oil and fully hydrogenated vegetable oil and (b) from 5% to 95% by weight of the fat composition of blending vegetable oil.

4. A dairy analogue composition according to claim 1, wherein the fat composition comprises (a) from 10% to 90% by weight of the fat composition of the interesterified blend of vegetable oil and fully hydrogenated vegetable oil and (b) from 10% to 90% by weight of the fat composition of blending vegetable oil.

5. A dairy analogue composition according to claim 1, wherein the fat composition comprises (a) from 50% to 80% by weight of the fat composition of the interesterified blend of vegetable oil and fully hydrogenated vegetable oil and (b) from 20% to 50% by weight of the fat composition of blending vegetable oil.

6. A dairy analogue composition according to claim 1, wherein the interesterified blend is an interesterified blend of from 20% to 60% by weight of vegetable oil and from 40% to 80% by weight of fully hydrogenated vegetable oil.

7. A dairy analogue composition according to claim 1, wherein the interesterified blend is an interesterified blend of from 45% to 55% by weight of vegetable oil and from 45% to 55% by weight of fully hydrogenated vegetable oil.

8. A dairy analogue composition according to claim 1, wherein the interesterified blend is an interesterified blend of liquid vegetable oil and fully hydrogenated vegetable oil.

9. A dairy analogue composition according to claim 1, wherein the interesterified blend is an interesterified blend of (i) fully hydrogenated vegetable oil and (ii) vegetable oil, each vegetable oil being selected from rapeseed oil, high oleic rapeseed oil, high erucic acid rapeseed oil, soybean oil, sunflower oil, high oleic sunflower oil, linseed oil, olive oil, corn oil, cottonseed oil, carinata oil, groundnut oil, safflower oil, high oleic safflower oil, peanut oil, rice oil, camelina oil, or any combination thereof.

10. A dairy analogue composition according to claim 1, wherein the interesterified blend is an interesterified blend of (i) fully hydrogenated vegetable oil and (ii) vegetable oil, each vegetable oil selected from rapeseed oil, high oleic rapeseed oil, high erucic acid rapeseed oil, or a combination thereof.

11. A dairy analogue composition according to claim 1, wherein the blending vegetable oil comprises rapeseed oil, high oleic rapeseed oil, soybean oil, sunflower oil, high oleic sunflower oil, linseed oil, olive oil, corn oil, cottonseed oil, groundnut oil, safflower oil, high oleic safflower oil, peanut oil, rice oil, camelina oil, or any combination thereof.

12. A dairy analogue composition according to claim 1, wherein the interesterified blend is an interesterified blend of (i) fully hydrogenated rapeseed oil, fully hydrogenated high oleic rapeseed oil, or a combination thereof; and (ii) rapeseed oil, high oleic rapeseed oil, or a combination thereof; preferably wherein the interesterified blend is an interesterified blend of (i) fully hydrogenated high oleic rapeseed oil and (ii) high oleic rapeseed oil.

13. A dairy analogue composition according to claim 1, wherein the fully hydrogenated vegetable oil comprises high erucic acid rapeseed oil, carinata oil, or any combination thereof.

14. A dairy analogue composition according to claim 13, wherein the interesterified blend is an interesterified blend of (i) fully hydrogenated rapeseed oil; (ii) fully hydrogenated high erucic acid rapeseed oil; and (iii) vegetable oil.

15. A dairy analogue composition according to claim 14, wherein the interesterified blend is an interesterified blend of (i) from 40% to 60% by weight of rapeseed oil; (ii) from 5% to 15% by weight of fully hydrogenated high erucic acid rapeseed oil; and (iii) from 30% to 50% by weight of fully hydrogenated rapeseed oil.

16. A dairy analogue composition according to claim 1, wherein the interesterified blend comprises less than 55% by weight of saturated fatty acid residues, wherein said percentages of fatty acid residues refers to fatty acids bound as acyl groups in glycerides in the interesterified blend and being based on the total weight of C4 to C24 fatty acid residues bound as acyl groups present in the interesterified blend.

17. A dairy analogue composition according to claim 1, wherein the interesterified blend comprises stearic acid residues in amount of from 40% to 60% and/or palmitic residues in an amount of 2.5% to 7.5%, wherein said percentages of fatty acid residues refers to fatty acids bound as acyl groups in glycerides in the interesterified blend and being based on the total weight of C4 to C24 fatty acid residues bound as acyl groups present in the interesterified blend.

18. A dairy analogue composition according to claim 1, wherein the interesterified blend has been produced by chemical interesterification, enzymatic interesterification, or a combination thereof.

19. A dairy analogue composition according to claim 1, wherein the dairy analogue composition is a cheese analogue composition comprising from 15% to 30% by weight of the fat composition; from 0% to 45% by weight of a starch; from 0% to 15% by weight of non-animal protein; and from 35% to 65% by weight of water.

20. A cheese analogue composition according to claim 19, wherein the starch comprises non-modified starch, modified starch, or a combination thereof.

21. A cheese analogue composition according to claim 19, wherein the starch comprises a non-modified or modified vegetable starch, rice starch, tapioca starch, wheat starch, or a combination thereof.

22. A cheese analogue composition according to claim 19, wherein the non-animal protein comprises plant protein such as algae protein, black bean protein, canola protein, chickpea protein, fava protein, lentil protein, lupin bean protein, mung bean protein, oat protein, pea protein, potato protein, rice protein, soy protein, sunflower seed protein, wheat protein, white bean protein, laboratory produced protein, and protein isolates or concentrates thereof; or wherein the nonanimal protein comprises seitan, mushroom protein, legume protein, tempeh, yam flour, tofu, mycoprotein, peanut flour, yuba, nuts, protein derived from nuts, or a combination thereof.

23. A cheese analogue composition according to claim 19, wherein the cheese analogue composition comprises one or more flavouring additives.

24. A cheese analogue composition according to claim 19, wherein the cheese analogue composition comprises one or more colouring additives.

25. A cheese analogue composition according to claim 19, wherein the cheese analogue composition further comprises an ionic or non-ionic emulsifier, a polyhydroxy compound, milk, liquid flavours, alcohols, humectants, honey, liquid preservatives, liquid sweeteners, liquid oxidising agents, liquid reducing agents, liquid anti-oxidants, liquid acidity regulators, liquid enzymes, milk powder, hydrolysed protein isolates (peptides), amino acids, yeast, sugar substitutes, salt, spices, fibre thickening and gelling agents, egg powder, enzymes, gluten, vitamins, preservatives, sweeteners, oxidising agents, reducing agents, anti-oxidants, acid, and acidity regulators.

26. A cheese analogue composition according to claim 19, wherein the cheese analogue composition comprises from 35% to 55% by weight of water; and wherein the combined weight percent of starch and non-animal protein in the cheese analogue composition is from 25% to 35%; preferably, wherein the cheese analogue composition is a cheddar cheese, parmesan cheese, pizza cheese, sandwich cheese, or similar-type cheese analogue composition.

27. A cheese analogue composition according to claim 19, wherein the cheese analogue composition comprises from 45% to 55% by weight of water; and wherein the combined weight percent of starch and non-animal protein in the cheese analogue composition is from 20% to 35%.

28. A cheese analogue composition according to claim 19, wherein the cheese analogue composition comprises from 50% to 65% by weight of water; and wherein the combined weight percent of starch and non-animal protein in the cheese analogue composition is from 5% to 25%.

29. A cheese analogue composition according to claim 1, wherein the fat composition has a solid fat content (SFC) N10 of less than 60, measured on unstabilised fat according to ISO 8292-1.

30. A cheese analogue composition according to claim 19, wherein the combined weight percent of starch and non-animal protein in the cheese analogue composition is less than 30%.

31. A dairy analogue composition according to claim 1, wherein the dairy analogue composition is a frozen dessert composition comprising from 1% to 20% by weight of the fat composition; from 10% to 40% by weight sugar; and from 30% to 80% by weight of water.

32. A dairy analogue composition according to claim 31, wherein the sugar comprises corn syrup, glucose syrup, glucose, fructose, sucrose, dextrin, dextrose, or a combination thereof.

33. A dairy analogue composition according to claim 31, wherein the dairy analogue composition further comprises from 1% to 10% by weight of solids derived from fruit or nut.

34. A dairy analogue composition according to claim 1, wherein the dairy analogue composition is a whipping cream composition comprising from 1% to 40% by weight of the fat composition and up to 80% by weight of water.

35. A dairy analogue composition according to claim 31, further comprising protein, wherein the protein is present in the dairy analogue composition in an amount of from 0.1% to 10% by weight of the composition.

36. A dairy analogue composition according to claim 31, wherein the dairy analogue composition further comprises one or more emulsifiers.

37. A dairy analogue composition according to claim 31, wherein the dairy analogue composition further comprises one or more hydrocolloid stabilisers.

38. A dairy analogue composition according to claim 1, wherein the dairy analogue composition further comprises an animal milk-derived protein.

39. A dairy analogue composition according to claim 1, wherein the dairy analogue composition is substantially free of animal protein and/or animal fats.

40. A dairy analogue composition according to claim 1, wherein the dairy analogue composition is substantially free of animal-derived products.

41. A dairy analogue composition according to claim 1, wherein the dairy analogue composition further comprises one or more animal-derived products such as animal oils, marine oils, animal-derived proteins, animal-derived polysaccharides, or any combination thereof.

42. A dairy analogue composition according to claim 41, wherein the one or more animal-derived products are present in the dairy analogue composition in an amount of from 1% to 20% by weight of the dairy analogue composition.

43. A food product comprising a dairy analogue composition according to claim 1.

44-51. (canceled)

52. A process of manufacturing a dairy analogue composition according to claim 1, wherein the process comprises combining a fat composition with water, and one or more additional components to form the dairy analogue composition, and forming the dairy analogue composition into food products.

53-54. (canceled)
